(19) United States
(12) Patent Application Publication
(10) Pub. No.: US 2025/0328220 A1
(43) Pub. Date: Oct. 23, 2025

(54) AI-Driven Method for Interactive Audiobook Creation on Any Platform via User Inputs

(71) Applicant: Ryan Andrew Nelson, Guyton, GA (US)

(72) Inventor: Ryan Andrew Nelson, Guyton, GA (US)

(21) Appl. No.: 18/642,561

(22) Filed: Apr. 22, 2024

(51) Int. Cl. G06F 3/0484; G06F 3/0482; G06F 3/16; G06F 40/58; G06T 11/00

(52) U.S. Cl. CPC G06F 3/0484; G06F 3/0482; G06F 3/16; G06F 40/58; G06T 11/00

(57) ABSTRACT

The present invention relates to an AI-driven system and method for generating customized audiobooks based on user inputs. The system comprises a user interface for receiving user inputs, including theme, genre, narrative elements, and voice selection; a processing unit with at least one AI model, such as a large language model (LLM) and an AI-driven narration model, for generating a personalized narrative based on the user inputs; and a memory unit for storing the generated audiobook in a suitable format. The AI models are trained on a dataset of pre-existing audiobooks, narratives, and voice samples to learn patterns, styles, and characteristics for generating the customized audiobook. The system is platform-agnostic, allowing audiobook creation and playback across various devices.

### BACKGROUND

The present invention relates generally to the field of audiobook generation and, more specifically, to AI-driven methods for interactive audiobook creation on any platform via user inputs.

Audiobooks, which are audio recordings of books read aloud, have gained significant popularity in recent years due to their convenience and accessibility. Traditional methods of audiobook production include recording voice actors reading a book in a studio, or using text-to-speech software to generate an audio version from the book's text. However, these methods offer limited personalization and interactivity for the end user.

Some existing techniques aim to enhance the audiobook experience through customization. For example, U.S. Pat. No. 8,934,717 discloses methods for automatically generating a story using semantic classifiers. The method involves receiving an incomplete story, processing it using semantic classifiers to identify semantic concepts, generating additional sentences based on these concepts, and producing a complete story. While this allows for some level of story customization, it does not provide the user with real-time interactivity in the audiobook creation process.

Another related technology is the use of artificial intelligence (AI) for content generation. AI models, such as large language models (LLMs), have been used to generate coherent narratives based on user prompts or inputs. However, the application of such AI models to create highly personalized, user-driven audiobooks that can be generated on-demand across different platforms has not been fully explored.

In summary, while existing methods allow for some audiobook customization and leverage AI for content generation, there remains a need for an AI-driven, interactive system that empowers users to create personalized audiobooks in real-time across various devices. The present invention addresses this need by providing a novel method and system for generating customized audiobooks based on user inputs, using advanced AI models, and delivering the audiobook on-demand on any platform.

### SUMMARY

The present invention is directed to an AI-driven method and system for interactive audiobook creation on any platform via user inputs. The system includes a user interface for receiving inputs such as theme, genre, narrative elements, and voice selection. A processing unit with AI models, including LLMs and AI narration models, generates a personalized narrative based on the user inputs. This narrative is converted into an audiobook format and stored in memory. The system is platform-agnostic, allowing audiobook creation and playback across devices.

In various embodiments, the AI models are trained on datasets of audiobooks, narratives, and voice samples. The system offers features such as content suggestions, visual representations of the audiobook, user feedback incorporation, translation to different languages, and editing of audiobook sections.

The invention provides an innovative approach to audiobook creation by giving users an unprecedented level of control and interactivity. By leveraging state-of-the-art AI, the system generates high-quality, emotionally engaging audiobooks tailored to individual preferences. This technology has the potential to revolutionize the audiobook industry and make personalized content more accessible to a wider audience.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates a system overview for generating customized audiobooks.

FIG. 2 depicts the user interface for receiving inputs and enabling user interactions.

FIG. 3 depicts a flowchart illustrating the key steps in generating the audiobook.

FIG. 4 illustrates the AI models and their training process within the processing unit.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

An artificial intelligence (AI) model, or AI model, is herein defined as a computer-implemented system comprising: a plurality of interconnected nodes arranged in one or more layers, the nodes configured to process input data and generate an output; a training module configured to train the interconnected nodes using a training dataset to perform one or more tasks, the training causing the AI model to learn and improve its performance at the one or more tasks over time absent human intervention; and an inference module configured to apply the trained AI model to new input data to generate a predicted output for performing the one or more tasks; wherein the AI model is trained to learn patterns, styles, and characteristics from the training dataset to generate the output.

An AI-driven narration model is herein defined as an artificial intelligence (AI) model configured to: receive input data representing one or more narrative elements, the one or more narrative elements including at least one of a theme, a plot, a character, a setting, or a desired tone; process the input data using a plurality of interconnected nodes arranged in one or more layers, the plurality of interconnected nodes trained on a dataset comprising a plurality of narrative examples; generate, as an output, a narrative incorporating the one or more narrative elements, the narrative comprising natural language text describing a sequence of narrative events wherein the AI-driven narration model is configured to generate the narrative absent predetermined rules for constructing narratives; and wherein the AI-driven narration model is further configured to generate the narrative by: identifying patterns and characteristics of the plurality of narrative examples from the dataset; and wherein the AI-driven narration model is further configured to generate the narrative by: identifying patterns and characteristics of the plurality of narrative examples from the dataset; and constructing the narrative incorporating the one or more narrative elements using the identified patterns and characteristics.

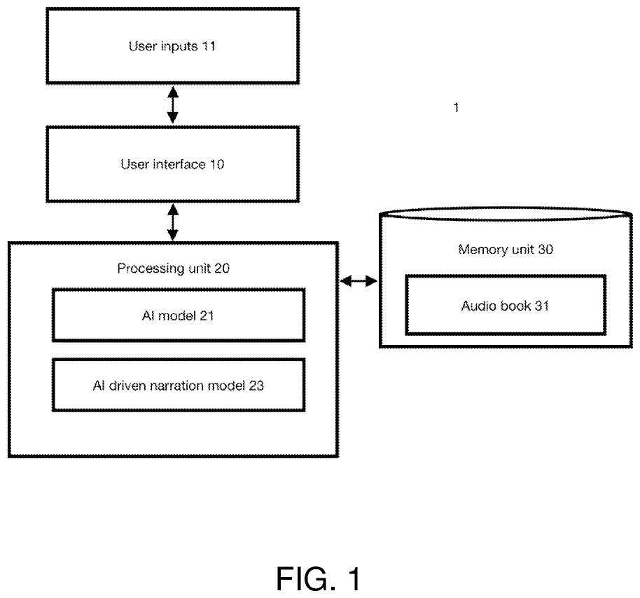

FIG. 1 illustrates a system overview for generating customized audiobooks. The system (1) comprises a user interface (10), such as a web-based front-end developed using HTML, CSS, and JavaScript frameworks like React or Angular, a processing unit (20) operatively coupled to the user interface (10), which may be implemented using a server-side technology stack such as Node.js, Express.js, or Django, and a memory unit (30) operatively coupled to the processing unit (20), which can be a cloud-based storage solution like Amazon S3 or Google Cloud Storage.

The user interface (10) is configured to receive user inputs (11), the user inputs (11) including at least one of a theme, a genre, a narrative, and a voice selection. The processing unit (20) includes at least one artificial intelligence (AI) model (21), the at least one AI model (21) including at least one of a large language model (LLM), such as GPT-3 or BERT, and an AI-driven narration model, which can be implemented using deep learning frameworks like TensorFlow or PyTorch.

The processing unit (20) is configured to receive the user inputs (11) from the user interface (10), generate a narrative based on the user inputs (11) using the at least one AI model (21), and convert the generated narrative into an audiobook format, such as MP3 or WAV, using text-to-speech libraries like Google Text-to-Speech or Amazon Polly. The memory unit (30) is configured to store the audiobook (31) in the audiobook format, which can be managed using a database management system like MongoDB or PostgreSQL.

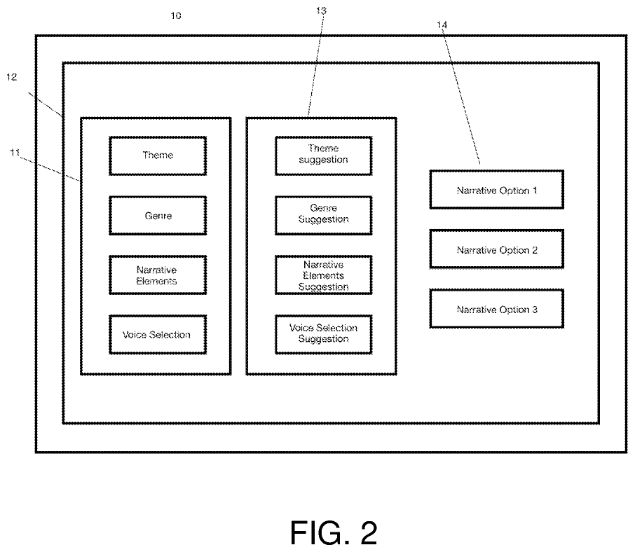

FIG. 2 depicts the user interface (10) for receiving inputs and enabling user interactions. The user interface (10) includes an input screen (12) for receiving user inputs (11), such as a theme, a genre, narrative elements, and voice selection, which can be implemented using form elements and input validation libraries like Formik or Yup. The user interface (10) also provides suggestions (13) for the theme, genre, narrative, and voice selection based on user preferences and historical data, which can be generated using recommendation algorithms like collaborative filtering or content-based filtering, and stored in a NoSQL database like Cassandra or Couchbase.

The user interface (10) presents generated narrative options (14) to the user for selection. These narrative options are generated by the at least one AI model (21) based on the user inputs (11) and can be rendered using front-end components like React components or Angular directives. The user can select a preferred narrative option, which is then converted into an audiobook format.

Additionally, the user interface (10) includes an audiobook editing interface (15) that allows users to select portions of the audiobook and provide additional inputs for generating revised versions of the selected portions. This feature enables user-driven customization and refinement of the generated audiobook and can be implemented using audio manipulation libraries like Web Audio API or Howler.js.

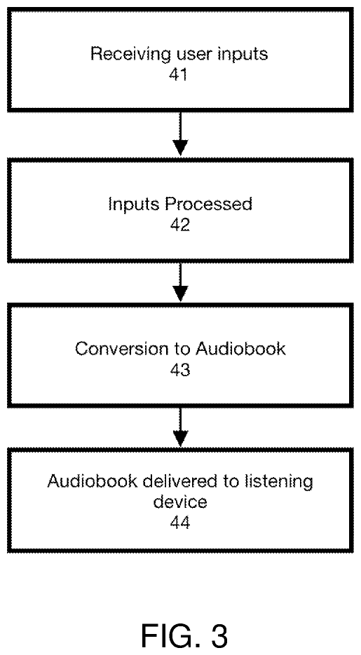

FIG. 3 depicts a flowchart illustrating the key steps in generating the audiobook (31). The process begins with receiving user inputs (11) via the user interface (10) (41). The user inputs (11) are then processed by the at least one AI model (21) within the processing unit (20) to generate a narrative (42). The generated narrative is converted into an audiobook format and stored as an audiobook (31) in the memory unit (30) (43). The audiobook (31) can be delivered to a plurality of devices (40), such as smartphones, tablets, or smart speakers, as the system (1) is platform-agnostic, leveraging cross-platform development tools like React Native or Flutter (44).

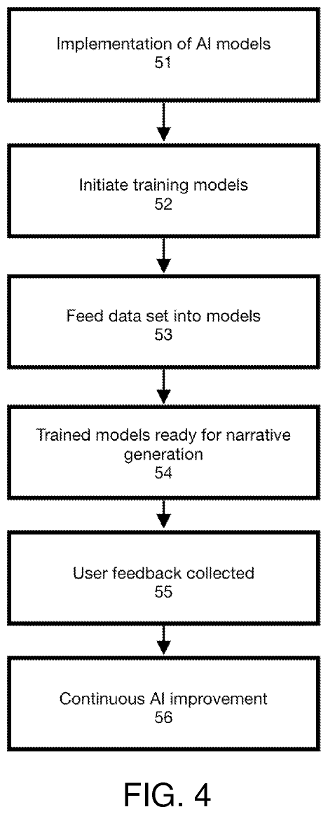

FIG. 4 illustrates the AI models and their training process within the processing unit (20). The at least one AI model (21) includes a large language model (LLM) (22), such as GPT-3 or BERT, and an AI-driven narration model (23), which can be implemented using deep learning frameworks like TensorFlow or PyTorch (51). These models are trained on a dataset (24) comprising a plurality of pre-existing audiobooks, narratives, and voice samples, which can be stored in a distributed file system like Hadoop Distributed File System (HDFS) or Amazon S3 (52).

The training process involves feeding the dataset (24) into the LLM (22) and the AI-driven narration model (23) to learn patterns, styles, and characteristics of audiobooks, narratives, and voices (53). This can be achieved using machine learning techniques like transfer learning, fine-tuning, or domain adaptation, and conducted using machine learning pipelines like Kubeflow or ML flow. The trained models are then used to generate narratives and convert them into audiobook format based on the user inputs (11) received via the user interface (10) (54).

Additional user feedback (25) is incorporated to update and refine the AI models (21) over time. The processing unit (20) receives user feedback (25) on the generated audiobooks via the user interface (10), which can be collected using feedback forms, rating systems, or sentiment analysis tools like VADER or TextBlob (55). This feedback is used to fine-tune the LLM (22) and the AI-driven narration model (23), enabling continuous improvement of the AI models based on user preferences and experiences, using techniques like online learning, reinforcement learning, or active learning (56).

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the related technical field of the present invention will readily appreciate that the present invention may be implemented in a wide variety of embodiments. This application is intended to cover any adaptations or variations of the preferred embodiments discussed herein. Therefore, it is manifestly intended that this invention be limited only by the claims and the equivalents thereof. It should be appreciated and understood that the present invention may be embodied as systems, methods, apparatus, computer readable media, non-transitory computer readable media and/or computer program products.

The present invention may take the form of an entirely hardware embodiment. an entirely software embodiment (including firmware, resident software, micro-code, etc.) or an embodiment combining software and hardware aspects that may all generally be referred to herein as a “circuit.” “module” or “system.” The present invention may take the form of a computer program product embodied in one or more computer readable mediums) having computer readable program code embodied thereon.

One or more computer readable medium(s) may be utilized. alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber. an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system. apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Inter-net using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer read-able medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flow chart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

What is claimed is:

1. A system for generating customized audiobooks, the system comprising:
a user interface configured to receive user inputs, the user inputs including at least one of a theme, a genre, a narrative, and a voice selection;
a processing unit operatively coupled to the user interface, the processing unit configured to:
receive the user inputs from the user interface;
generate a narrative based on the user inputs using at least one artificial intelligence (AI) model, the at least one AI model including at least one of a large language model (LLM) and an AI-driven narration model; and
convert the generated narrative into an audiobook format; and
a memory unit operatively coupled to the processing unit, the memory unit configured to store the audiobook in the audiobook format, wherein the system is platform-agnostic and configured to operate on a plurality of devices.

2. The system of claim 1, wherein the at least one AI model is trained on a dataset comprising a plurality of pre-existing audiobooks, narratives, and voice samples.

3. The system of claim 1, wherein the user inputs comprise at least one of a desired length of the audiobook, a target audience, a language, an accent for the voice selection, and a desired tone.

4. The system of claim 1, wherein the user interface is configured to provide suggestions for the theme, the genre, the narrative, and the voice selection based on user preferences and historical data.

5. The system of claim 1, wherein the generated narrative includes at least one of dialogue, character development, scene descriptions, and plot progression.

6. The system of claim 1, wherein the at least one AI model is configured to generate multiple narrative options based on the user inputs, and wherein the user interface is configured to present the multiple narrative options to the user for selection.

7. The system of claim 1, wherein the audiobook format includes at least one of an MP3 format, a WAV format, and an AAC format.

8. The system of claim 1, wherein the processing unit is further configured to:
receive, via the user interface, user feedback on the audiobook; and
update the at least one AI model based on the user feedback.

9. The system of claim 1, wherein the processing unit is further configured to generate a visual representation of the audiobook, the visual representation including at least one of cover art, chapter illustrations, and character visualizations, and wherein the memory unit is configured to store the visual representation in association with the audiobook.

10. The system of claim 1, wherein the visual representation is generated using at least one of a generative adversarial network (GAN), a variational autoencoder (VAE), and a stable diffusion model.

11. The system of claim 1, wherein the processing unit is further configured to:
receive, via the user interface, a user selection of a portion of the audiobook; and
generate a revised version of the selected portion based on additional user inputs.

12. The system of claim 1, wherein the processing unit is further configured to:
receive, via the user interface, a user request to translate the audiobook into a different language; generate a translated version of the audiobook using a machine translation model; and store the translated version of the audiobook in the memory unit.

13. A method for generating customized audiobooks, the method comprising:
receiving, via a user interface, user inputs including at least one of a theme, a genre, a narrative, and a voice selection;
generating, using a processing unit operatively coupled to the user interface, a narrative based on the user inputs using at least one AI model, the at least one AI model including at least one of a LLM and an AI-driven narration model;
converting, using the processing unit, the generated narrative into an audiobook format; and
storing, in a memory unit operatively coupled to the processing unit, the audiobook in the audiobook format, wherein the method is performed by a platform-agnostic system configured to operate on a plurality of devices.

14. The method of claim 13, wherein the at least one AI model is trained on a dataset comprising a plurality of pre-existing audiobooks, narratives, and voice samples.

15. The method of claim 13, wherein the memory unit is a cloud-based storage system accessible via the internet.

16. The method of claim 13, further comprising:
receiving, via the user interface, user feedback on the audiobook; and
updating, using the processing unit, the at least one AI model based on the user feedback.

17. The method of claim 13, wherein the platform-agnostic system is configured to operate on at least one of a smartphone, a tablet, a desktop computer, a laptop computer, a smart speaker, and a wearable device.

18. The method of claim 13, further comprising:
generating, using the processing unit, a visual representation of the audiobook, the visual representation including at least one of cover art, chapter illustrations, and character visualizations; and storing, in the storage unit, the visual representation in association with the audiobook.

19. The method of claim 18, wherein the visual representation is generated using at least one of a generative adversarial network (GAN), a variational autoencoder (VAE), and a stable diffusion model.

20. The method of claim 13, further comprising:
receiving, via the user interface, a user selection of a portion of the audiobook;
and generating, using the processing unit, a revised version of the selected portion based on additional user inputs.
